(19) United States
(12) Patent Application Publication
(10) Pub. No.: US 2007/0172317 A1
(43) Pub. Date: Jul. 26, 2007

(54) Multi purpose file holder model 2

(76) Inventor: Michael Gary Petrillo, Las Vegas, NV (US)

Correspondence Address: MIchael Petrillo, 5912 Carpenteria Way, Las Vegas, NV, 89108, US

(21) Appl. No.: 11/642,562

(22) Filed: Dec. 21, 2006

Related U.S. Application Data
(63) Continuation of application No. 60/761,853, filed on Jan. 25, 2006.

(51) Int. Cl. B23B 31/12; B26D 1/12

(52) U.S. Cl. 407/29; 279/42; 407/29.15

(57) ABSTRACT

Files of different sizes and shapes are secure in place, in the fingers of a conventional medium size tap wrench by screwing down the ferrule which is larger in format then the threaded nut used on tap wrenches now, for a better grip to hold and tighten the fingers around the file tangs and using redesign tap wrench shaft. Taking out the T-handle section and replacing with a hexagonal shaft. A one piece unit for inserting into a wood handle or molded into a plastic handle using the same size tap wrench shaft used for the invention, not the sizes that are sold in stores today.

### BACKGROUND OF THE INVENTION

This invention relates to an improved way to hold secure machinists files and wood files, Even more it specifically relates to any size or shape machinist and wood file tang. and any tool that has a shank and no handle, who's diameter fits in the shank opening

The problem today with file tangs is there is no set standards. Each Manufacturer sets its own shape and size, because of this one file may work in one handle but not another. Even if the files are the same length or texture it may have a different size tang making it unable to fit into the handle you have.

Also most wood handles for files have to be hit on to the file tang with a hammer. Once put on it stays there until it breaks. In most cases it is not usable again, and if it can be re used it is not in good shape or not safe to use.

There for with wood handles that are hammered on to the file tang, you would need a separate handle to accommodate all the different size file tangs which could be costly.

There are a set of file handles in which the handles screws on to the file tang. You will still need nine sizes of these handles to hold all the different size of files.

Plastic file handles also have the same problem as wood handles. If using a plastic file handle you would still need at least four different size inserts to accommodate the different size file tangs, also plastic handles have smaller holes which makes it difficult for the files to be held securely on the handles for use.

When using a file without a handle for a long period of time it can be uncomfortable. Therefor a file holder that can hold all sizes and all shapes of tangs and that is fitted to a wood handle or plastic handle of a good size is needed. That's what this invention answers.

### BRIEF SUMMARY OF THE INVENTION

The present invention resides in a file holder that can handle any and all sizes of files and shape of tangs. In a tight and secure hold.

Therefor there is no worry of the file slipping out of the handle, or any movement of the file in a side to side motion.

You now have a reusable file handle, that you can easy and quickly change files out. Your cost will be less then having to have a file handle for each file.

The idea behind the invention is to make a file holder that can hold all shape and size of files and file tangs. It is an easy to manufacture method and in a cost effective manner. In which this file holder design reaches both those points. The size tap wrench shaft that was used in the invention is not a off the shelf product item, but would be no problem to machine set up to a manufacture the size.

### BRIEF DESCRIPTION OF THE SEVERAL VIEWS OF THE DRAWING

FIG. 1 Is a side view of part of a medium size conventional tap wrench shaft with the T-section removed, and a hexagon section put in its place. The entire shaft would be a one piece unit.

FIG. 2 Is a top view of the medium size conventional tap wrench shaft opening and four fingers.

FIG. 3 Is a bottom view of the hexagon section of the redesign medium size conventional tap wrench shaft.

FIG. 4 Is a side view of the ferrule in which the bottom part is round with raised metal for a better hand grip. And the top part being oval in shape and slanted inwards.

FIG. 5 Is a bottom view of the ferrule in which the bottom part is round.

FIG. 6 Is a top view of the metal front end of the cap, that goes over the top part of the wood handle. This is standard on wood handles, and can be made for plastic handles.

FIG. 7 Is a side and front view of the metal front end cap that goes over the top part of the wood handle.

### DETAILED DESCRIPTION OF THE INVENTION

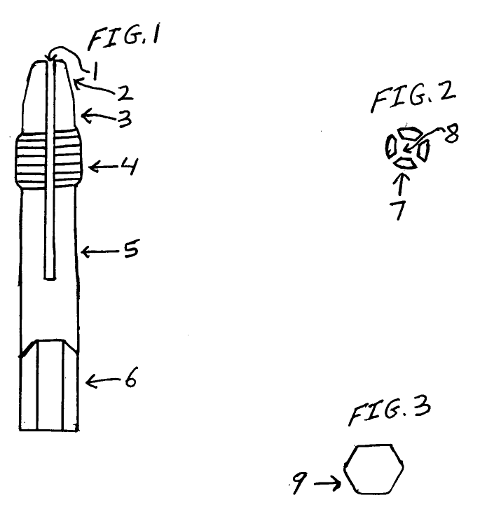

As shown in (FIG. 1). We are taking a medium size conventional tap wrench and re designing the lower part by taking out the T handle and putting 6 a Hexagonal shaft in place. The entire shaft in (FIG. 1) is a one piece unit. Out of the three sizes of conventional tap wrenches small medium large most places now sell only the small and large size. The medium size is the most difficult to find if it can be found. Only the medium conventional tap wrench can hold all the different sizes and shape file tangs, the small can only hold small size file tangs but they are not held as secure as they should be. The large size tap wrench can only hold some large file tangs but again they are not held as secure as they should be. The medium size tap wrench fingers (FIG. 1) 2,3 can wrap around the file tangs and hold them secure.

In (FIG. 1) 1, 2,3,4,5 stay the same as they are now on a medium size tap wrench. The new part being 6 to the shaft.

As shown in the drawing (FIG. 1) 1,2,3,4,5 shows what the medium size conventional tap wrench upper fingers part look like. The other side of the upper fingers part of the tap wrench not shown is the same as what is shown in (FIG. 1) 1,2,3,4,5 in (FIG. 1) The T handle that is normally on the bottom part of a conventional tap wrench. Was removed and replaced with 6 a hexagonal shape shaft. (FIG. 1) 1 is the opening were a tap wrench is normally inserted instead a file tang would be inserted into 1. The upper part of the shaft finger 2, 3 wrap around the file tangs and hold it secure, when (FIG. 5) The ferrule nut is threaded down on 4 the threaded section of the shaft. Section 5 of the shaft helps to hold round files that have long thin size tangs. The bottom section 6 of the shaft is hexagonal in shape. So when inserted in to a wood handle of your choice. The section 6 becomes locked into the wood. And cannot be moved from side to side or even pulled out of the handle by hand. Section 6 can also be used in plastic handle with the plastic being molded around section 6 to also give it the same holding force as a wood handle.

In (FIG. 2) A top view of the 7 fingers and 8 openings where the file tangs are inserted of the shaft.

In (FIG. 3) A bottom view of the 9 Hexagonal part of the shaft.

In (FIG. 4) As shown is a side view of the ferrule with the bottom part 12 being round in shape and the bottom part having 13 raised metal for a better hand grip with the 11 top part being oval in shape and slanted inwards. The hole 10 opening in top is where the file tangs go. The Ferrule in (FIG. 4) can be made on the outside diameter to any size, to fit the wood or plastic handle you are using. The inside diameter 10 of the ferrule opening would remain the same as the threaded nut is now on for the medium size tap wrench used for the invention. This ferrule (FIG. 4) would be a moveable up and down ferrule.

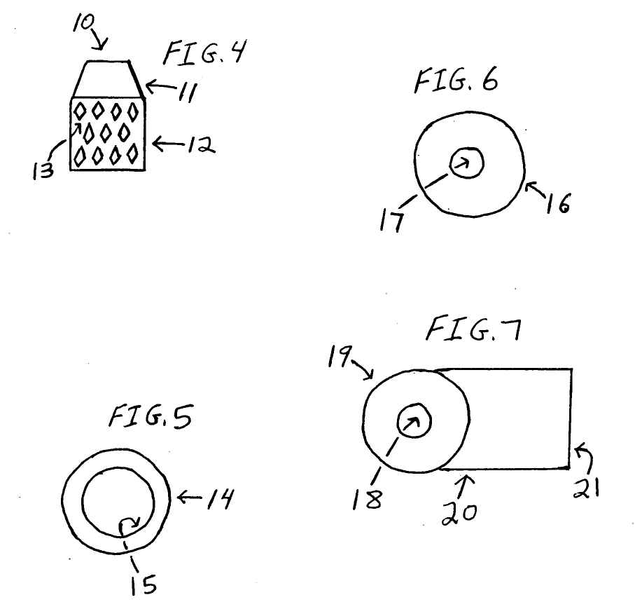

As shown in (FIG. 5) is a bottom view of the ferrule which is round in shape 14 and the hole 15 with the threads around the inside. Fits over the shaft and screws down onto (FIG. 1) 4 to tighten the fingers around the file tang. The ferrule would be movable up and down. As Shown in (FIG. 6) 16 top view of front metal cap. 17 hole for cap.

As shown (FIG. 7) is a side view of the metal cap for wood file handles. The round metal side 17 that covers over the front part of the wooden handle. The area 18 where the wood handle inserts into the metal cap and the top front 20 part that faces the file. The 19 hole where the file holder shaft goes through.

### Materials

A variety of materials can be used. Hardened steel for the shaft and ferrule. And or the steel that tap wrenches are made from today. You want a metal that is not to heavy, but yet is strong to hold up.

The shaft would be manufacture the way a tap wrench is now. However instead of the round bottom and the sliding T handle. That section would be hexagonal.

The ferrule nut would be manufacture the way a tap wrench nut is today, with the size of the outside being enlarged.

The front end cap would be made of steel and manufacture the way front end cap for wood file handles are today.

### Operation

Operation of the file holder is simple and straight forward. Loosened the ferrule nut insert the file tang into the shaft opening as far down as it will go then tighten down the ferrule by hand. You can also hold the round ferrule and tighten the fingers by turning the file handle. You can screw down the ferrule and screw up the file handle and tighten the fingers to close around the file tangs.

The part round shape ferrule on the bottom and oval slanted in the top part is made for all the different file tangs shapes and sizes that only need to be hand tightened for a secure hold and the round shape of the bottom is comfortable on your hands.

I claim:

1. A Multi Purpose File Holder Model 2
Being a re design medium size conventional tap wrench re design on the bottom part with the T-handle section removed and a hexagonal shaft put in place, with the top fingers section of the tap wrench remaining the same for a one piece shaft.
A standard but outside diameter enlarge tap wrench threaded nut, which would become a moveable ferrule.
